(19) United States
(12) Patent Application Publication
(10) Pub. No.: US 2025/0108905 A1
(43) Pub. Date: Apr. 3, 2025

(54) Barrier Door with Stowage Frame

(71) Applicant: The Boeing Company, Arlington, VA (US)

(72) Inventors: Daniel Bryan Nunes, Snohomish, WA (US); Steven Ellis Rhynard, Mukilteo, WA (US); Gregory Staton Smith, Edmonds, WA (US); Hakeem Haj-Musa, Bellevue, WA (US); Sean Michael Finerty, Bothell, WA (US); Nathan Lee Near, Arlington, WA (US); Daniel Paul Warren, Lake Stevens, WA (US); Paul Addis, Bothell, WA (US); Kyong S. Kim, Mill Creek, WA (US)

(21) Appl. No.: 18/814,956

(22) Filed: Aug. 26, 2024

Related U.S. Application Data
(60) Provisional application No. 63/541,955, filed on Oct. 2, 2023.

(51) Int. Cl. B64C 1/14; E06B 3/48

(52) U.S. Cl. CPC B64C 1/1469; B64C 1/1461; E06B 3/481

(57) ABSTRACT

A barrier door system to control movement of persons through an opening in an interior space of an aircraft. The barrier door system having a frame with outer members that extend around a gap. A barrier door has a first panel and a second panel that are pivotally connected together with the barrier door pivotally connected to the frame. The barrier door is movable between a stowed position and a deployed position. The stowed position includes the first panel and the second panel folded together in an overlapping configuration and positioned in the gap in the frame and away from the opening. The deployed position includes the first panel and the second panel positioned away from the gap and extending across the opening.

### RELATED APPLICATIONS

This application claims priority to U.S. Provisional Patent Application Ser. No. 63/541,955 filed on Oct. 2, 2023, which is incorporated herein by reference in its entirety.

### TECHNOLOGICAL FIELD

The present disclosure relates generally to the field of aircraft and, more specifically, to a barrier door configured to control movement of persons through an opening within the interior of the aircraft.

### BACKGROUND

Aircraft have a flight deck that includes flight instruments, instrument panels, and various controls that enable the flight personnel to operate the aircraft. The flight deck is positioned towards the front of the aircraft and is usually a separate compartment away from the cabin area where passengers sit during flight. A flight deck door further separates the flight deck from the cabin area.

The flight deck door is closed and locked during flight. This allows the flight personnel to concentrate on operating the aircraft and prevents entry of unauthorized persons onto the flight deck. However, the flight deck door may be opened during flight for various reasons. One occurrence is when flight personnel use the lavatory which is located in the cabin area of the aircraft. Other occurrences are when food and/or drinks that are prepared in the galley of the cabin area are delivered to the flight personnel on the flight deck, and when flight personnel leave the flight deck during a break.

Opening of the flight deck door could present an opportunity for an unauthorized person to gain entry to the flight deck.

A physically installed system is needed that would inhibit and/or sufficiently delay a person in the cabin area from reaching the flight deck door when the flight deck door is open. The delay in their movement towards the flight deck would allow the flight deck door to be closed and locked prior to the person reaching the door.

### SUMMARY

One aspect is directed to a barrier door system to control movement of persons through an opening in an interior space of an aircraft. The barrier door system comprises a frame that comprises outer members that extend around a gap. A barrier door comprises a first panel and a second panel that are pivotally connected together with the barrier door pivotally connected to the frame. The barrier door is movable between a stowed position and a deployed position. The stowed position comprising the first panel and the second panel folded together in an overlapping configuration and positioned in the gap in the frame and away from the opening. The deployed position comprising the first panel and the second panel positioned away from the gap and extending across the opening.

In another aspect, the frame comprises a first post and a second post with bottom ends configured to connect to a floor of the aircraft and a header that extends across top ends of the first post and the second post.

In another aspect, the barrier door is pivotally connected to the first post.

In another aspect, the barrier door further comprises one or more additional panels that are folded together with the first panel and the second panel in the stowed position.

In another aspect, each of the first panel and the second panel comprises a front side and a rear side with the front sides facing together in the stowed position.

In another aspect, just the rear side of the first panel is exposed in the frame in the stowed position.

In another aspect, anchors are configured to receive an outer edge of the second panel in the deployed position with the anchors comprising a slot with a width that tapers inward away from the opening.

In another aspect, the anchors comprise a forward extension and a rear extension that are spaced apart by the slot with the forward extension comprising a vertical wall that is contacted by the second panel in the deployed position.

In another aspect, the first panel is configured to pivot greater than 90° about the frame to enable the barrier door to move from the stowed position to the deployed position.

In another aspect, a frame hinge that connects the first panel to the frame with the frame hinge being covered and not visible from a cabin area of the aircraft in both the stowed position and the deployed position.

In another aspect, the barrier door and the frame are mounted to one or more of the ceiling and the floor of the aircraft and are positioned away from one or more monuments within the aircraft.

In another aspect, a latch is mounted to one or more of the first panel and the second panel with the latch configured to secure the first panel and the second panel together in the deployed position.

One aspect is directed to a barrier door system mounted at an opening in an interior space of an aircraft with the opening formed between a first side wall, a second side wall, a floor, and a ceiling. The barrier door system comprising a frame comprising outer members that form a gap. A barrier door comprises a first panel and a second panel that are pivotally connected together with the first panel pivotally mounted to the frame. One or more anchors mounted to one or both of the floor and the ceiling at the second side wall. The barrier door is movable between a stowed position and a deployed position. The stowed position comprises the first panel and the second panel folded together in an overlapping configuration and positioned in the gap in the frame and the deployed position comprises the first panel and the second panel positioned in a non-overlapping configuration and positioned out of the gap and extending across the opening.

In another aspect, the first panel and the second panel are positioned in an end-to-end configuration in the deployed position.

In another aspect, the frame is mounted with the gap aligned parallel to the first side wall.

In another aspect, the first side wall is formed by a first monument and the second side wall is formed by a second monument and wherein the frame, the barrier door, and the one or more anchors are mounted to just one or more of the floor and the ceiling.

In another aspect, a frame hinge connects the first panel to the frame and wherein the frame hinge is positioned on a front side of the barrier door and away from a cabin area of the aircraft in the deployed position.

In another aspect, the barrier door is aligned perpendicular to each of the first side wall and the second side wall in the deployed position.

In another aspect, the barrier door is positioned rearward of a flight deck door within the interior space of the aircraft.

One aspect is directed to a method of deploying a barrier door within an interior of an aircraft. The method comprises: positioning the barrier door in a stowed position within a gap in a frame and with a first panel and a second panel of the barrier door in a folded configuration with the first panel and the second panel positioned on a front side of an opening in the aircraft; pivoting the first panel and the second panel about a frame hinge from the front side of the opening to a rear side of the opening and the frame hinge connects the barrier door to the frame; and pivoting the first panel and the second panel to the deployed position that extends across the opening and with the inner edges of the first panel and the second panel positioned together.

In another aspect, the method further comprises engaging a latch and securing the first panel and the second panel in the deployed position.

One example is directed to a barrier door system to control movement of persons through an opening in an interior space of an aircraft. The barrier door system comprises a frame that comprises outer members that extend around a gap, and a barrier door comprising a first panel and a second panel that are pivotally connected together along inner edges with the barrier door pivotally connected to the frame. The barrier door is movable between a stowed position and a deployed position. The stowed position comprises the first panel and the second panel folded together in an overlapping configuration and positioned in the gap in the frame and away from the opening. The deployed position comprises the first panel and the second panel positioned in an end-to-end configuration and positioned out of the gap and extending across the opening.

In another example, the frame comprises a first post and a second post with bottom ends configured to connect to a floor of the aircraft and a header that extends across top ends of the first post and the second post.

In another example, the barrier door is pivotally connected to the first post.

In another example, each of the first panel and the second panel comprises a front side and a rear side with the front sides facing together in the overlapping configuration.

In another example, just the rear side of the first panel is exposed in the frame in the overlapping configuration.

In another example, anchors are configured to receive an outer edge of the second panel in the deployed position with the anchors comprising a slot with a width that tapers inward away from the opening.

In another example, the anchors further comprise a forward extension and a rear extension that are spaced apart by the slot with the forward extension comprising a vertical wall that is contacted by the second panel in the deployed position.

In another example, the first panel pivots greater than 90° about the frame when moving from the stowed position to the deployed position.

In another example, a panel hinge connects the first panel to the frame with the panel hinge being covered and not visible from a cabin area of the aircraft in both the stowed position and the deployed position.

In another example, the barrier door and the frame are mounted to one or more of the ceiling and the floor of the aircraft and are positioned away from one or more monuments within the aircraft.

In another example, a latch is mounted to one or more of the first panel and the second panel with the latch configured to secure the panels together in the deployed position.

One example is directed to a barrier door system mounted at an opening in an interior space of an aircraft with the opening formed between a first side wall, a second side wall, a floor, and a ceiling. The barrier door system comprises a frame comprising outer members that extend around a gap, the frame mounted with the gap aligned parallel to the first side wall. A barrier door comprising a first panel and a second panel that are pivotally connected together along inner edges with the first panel pivotally mounted to the frame. One or more anchors are mounted to one or both of the floor and the ceiling at the second side wall. The barrier door is movable between a stowed position and a deployed position. The stowed position comprises the first panel and the second panel folded together in an overlapping configuration and positioned in the gap in the frame. The deployed position comprises the first panel and the second panel positioned in an end-to-end configuration and positioned out of the gap and extending across the opening.

In another example, the first side wall is formed by a first monument and the second side wall is formed by a second monument and wherein the frame, the barrier door, and the one or more anchors are mounted to just one or more of the floor and the ceiling.

In another example, the frame, the barrier door, and the one or more anchors are not mounted to either the first monument or the second monument.

In another example, the barrier door is aligned perpendicular to each of the first side wall and the second side wall in the deployed position.

In another example, the barrier door is positioned rearward of a flight deck door within the interior space of the aircraft.

In another example, a panel hinge connects the first panel to the frame, wherein the panel hinge is covered in the stowed position by the first panel.

In another example, the panel hinge is positioned on a front side of the barrier door and away from a cabin area of the aircraft in the deployed position.

One example is directed to a method of deploying a barrier door within an interior of an aircraft. The method comprises: positioning the barrier door in a deployed position within a gap in a frame and with a first panel and a second panel of the barrier door in a folded configuration with the first panel and the second panel positioned on a front side of an opening in the aircraft; pivoting the first panel and the second panel about a frame hinge from the front side of the opening to a rear side of the opening and the frame hinge connects the barrier door to the frame; unfolding the second panel away from the first panel while inner edges of the panels remain on the rear side of the opening; and pivoting the first panel and the second panel to the deployed position that extends across the opening and with the inner edges of the panels positioned together.

In another example, the method comprises abutting together the inner edges of the panels in the deployed position.

In another example, the method comprises engaging a latch and securing the first panel and the second panel in the deployed position.

In another example, the method comprises pivoting the first panel and the second panel about the frame hinge from the front side of the opening to a rear side of the opening while the first panel and the second panel remain in the folded configuration.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an isometric view of an aircraft.

FIG. 2 is a top schematic diagram of an interior of an aircraft with a barrier door system mounted at an opening.

FIG. 3 is an isometric view from a vestibule of a barrier door that is in a deployed position.

FIG. 4 is an isometric view from a cabin area of the barrier door of FIG. 3.

FIG. 5 is an isometric view of a hinge that connects a barrier door to a frame.

FIG. 6 is an isometric view of a hinge that connects a barrier door to a frame.

FIG. 7 is a schematic side view of a barrier door with a latch that secures the door in position suing floor and ceiling strikes latching rods.

FIG. 7A is an isometric view of an anchor.

FIG. 8 is an isometric view of an anchor.

FIG. 9 is an isometric view of an outer edge of a barrier door positioned within a slot in an anchor.

FIG. 10A-10D are top schematic diagrams of a barrier door moving from a stowed position in a folded configuration to a deployed position in an extended configuration.

FIG. 11 is a schematic top view of a barrier door shown in light lines in a partially deployed position and solid lines in a deployed position.

FIG. 11A is an enlarged view from FIG. 11 of the outer edge of the door mounted in the anchor.

FIG. 12 is a flowchart diagram of a method of deploying a barrier door within an interior of an aircraft.

### DETAILED DESCRIPTION

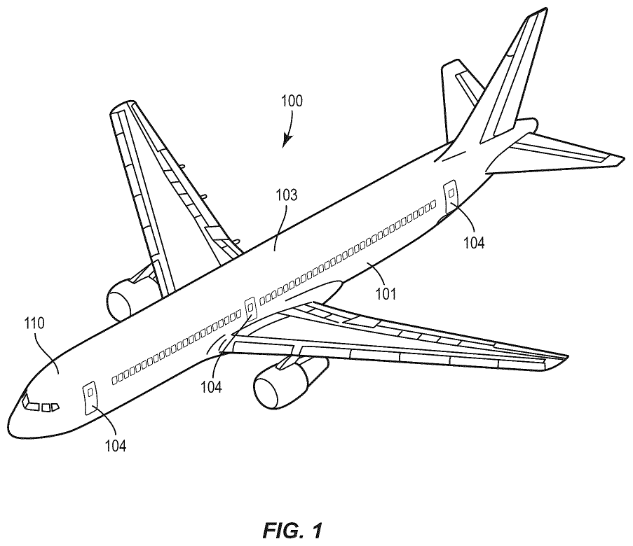

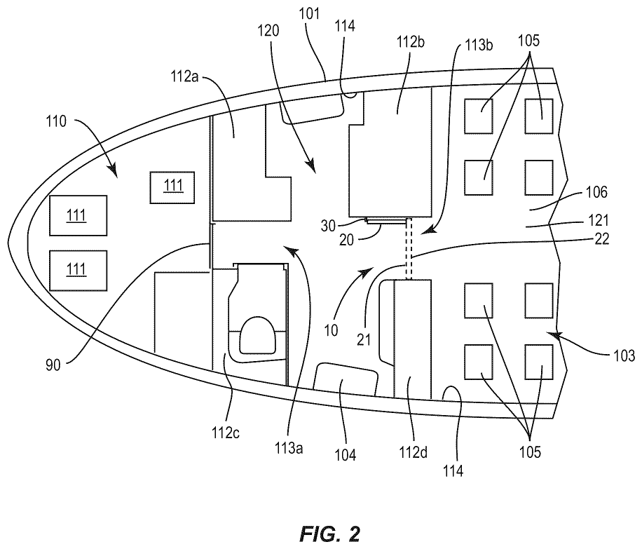

FIGS. 1 and 2 illustrate an aircraft 100 configured to transport passengers. The aircraft 100 includes a fuselage 101 with a flight deck 110 positioned at the front and a cabin area 103 positioned rearward. The cabin area 103 is equipped for accommodating the passengers. The size of the flight deck 110 and the cabin area 103 can vary depending upon the aircraft 100. One or more exterior doors 104 provide for passengers and the flight personnel to enter and exit the fuselage 101.

The flight deck 110 includes one or more seats 111 for flight personnel including but not limited to the pilot, co-pilot, and other authorized persons. Various controls and instrument panels (not illustrated) are located for use by the flight personnel to control the aircraft 100.

The cabin area 103 is positioned along the fuselage 101 rearward of the flight deck 110. The cabin area 103 includes a passenger section 121 with seats 105 arranged in rows along one or more aisles 106. In some examples such as a commercial airline, the seats 105 extend throughout the cabin area 103. In other examples in which the aircraft 100 is used for cargo transport, a limited number of seats 105 are positioned in the cabin area 103.

Monuments 112 are mounted to the structural members of the aircraft 100 within the fuselage 101. The monuments 112 are shaped and sized for a function with examples including but not limited to galleys, lavatories, walls, and stowage units. In some examples, the monuments 112 are shaped and sized to extend from the floor to the ceiling of the cabin area 103, and between a wall 114 of the fuselage 101 to an aisle 106.

In some examples, the cabin area 103 includes a vestibule 120 positioned between the flight deck 110 and the passenger section 121. In some examples, the vestibule 120 is positioned at one of the exterior doors 104 and includes space to allow for passengers to enter and exit the aircraft 100. Additionally or alternatively, the vestibule 120 provides an area for flight personnel to sit during takeoff and landing, for the flight personnel to prepare food/drinks, and for passengers to access a lavatory. FIG. 2 includes the vestibule 120 having a pair of galley monuments 112a, 112b, a lavatory monument 112c, and a stowage monument 112d. In other examples, the cabin area 103 does not include a vestibule with the passenger section 121 including the seats 105 extending directly behind the flight deck 110.

One or more openings 113 allow persons to move within the cabin area 103. The openings 113 form walkways for passengers and flight personnel to move within the cabin area 103. In some examples as illustrated in FIG. 2, the openings 113 are formed between the monuments 112. FIG. 2 illustrates a layout with a pair of openings-opening 113a formed closer to the flight deck 110 and opening 113b closer to the passenger section 121. Other examples include openings 113 formed between various components, such as monuments 112, walls 114 of the fuselage 101, and seats 105.

A flight deck door 90 separates the flight deck 110 from the cabin area 103. In some examples the flight deck door 90 separates the flight deck 110 from the vestibule 120. The flight deck door 90 prevents unauthorized persons from entering the flight deck 110 from the cabin area 103. The flight deck door 90 can include a lock to secure the door 90 in the closed position.

The present application is directed to a barrier door system 10 configured to delay and/or prevent a passenger in the cabin area 103 from moving through an opening 113 and gaining access to the flight deck 110. The barrier door system 10 includes a barrier door 20 and a frame 30. The barrier door 20 is movable between a stowed position (shown in solid lines in FIG. 2) and a deployed position (shown in dashed lines in FIG. 2). In the stowed position, the barrier door 20 is folded and positioned in the frame 30. This allows for persons to move through the opening 113 such as during boarding and deplaning. In the deployed position, the barrier door 20 is in an extended configuration that extends across the opening 113. This prevents and/or delays a person in the cabin area 103 from moving through the opening 113 and gaining access to the flight deck 110.

In some examples as illustrated in FIG. 2, the barrier door 20 is perpendicular to one or both of the side walls when in the deployed position. In other examples, the barrier door 20 is at a non-perpendicular angle in the deployed position. In the non-perpendicular positions, the door 20 can angle either forward or aft.

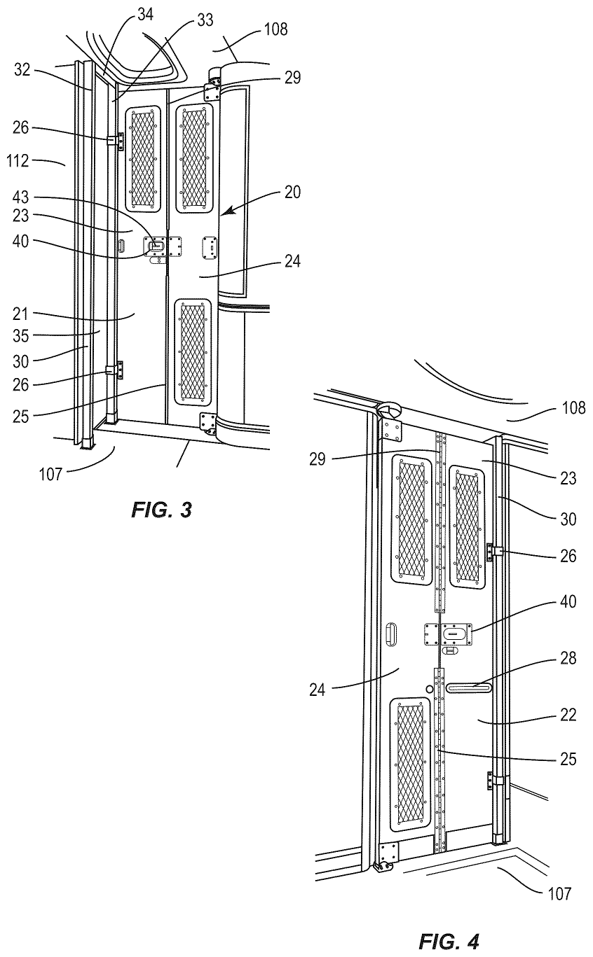

In the deployed position, the barrier door 20 includes a front side 21 that faces forward towards the flight deck 110. The barrier door 20 also includes a rear side 22 that faces rearward towards the cabin area 103. FIGS. 3 and 4 illustrate the front side 21 and rear side 22 respectively of a barrier door 20 in the extended configuration and in the deployed position. The barrier door 20 includes panels 23, 24 that are connected along inner edges 29 together by a panel hinge 25. The panels 23, 24 are constructed from a rigid material (e.g., composite material, plastic) and have a fixed shape. The panels 23, 24 can include various shapes and sizes including rectangular as shown. In some examples, the panels 23, 24 are sized to extend across the entire opening 113 such that there are no gaps when in the deployed position. In other examples, one or more small gaps are formed along the outer edges of the panels 23, 24. In some examples, the panels 23, 24 have the same shape and size to completely overlap in the folded configuration. In other examples, the panels 23, 24 include different shapes and/or sizes. One or more windows can be positioned on one or both panels 23, 24. As illustrated in FIG. 4, a stowage latch 28 is mounted on the rear side of panel 23. In some examples, the latch 28 is slidably mounted in a panel cutout feature with a cover and movable between extended and a recessed positions. In some examples, the latch 28 is a slam latching mechanism.

The panel hinge 25 is positioned at the inner edges 29 of the panels 23, 24. The panel hinge 25 can extend along a single continuous section of the inner edges 29 or can include two or more discrete sections. The panel hinge 25 can include various configurations, including but not limited to a piano hinge. The panel hinge 25 provides for relative movement of the panels 23, 24 between the extended and folded configurations. In some examples, the panel hinge 25 provides for the panels 23, 24 to be parallel in the folded configuration. This minimizes the overall size of the barrier door 20 when in the stowed position to provide for persons to pass through the opening 113. In some examples, the panel hinge 25 aligns the panels 23, 24 in a co-linear position in the extended configuration to extend across the opening 113. In other examples, the panels 23, 24 are positioned at different relative angular positions in the extended configuration.

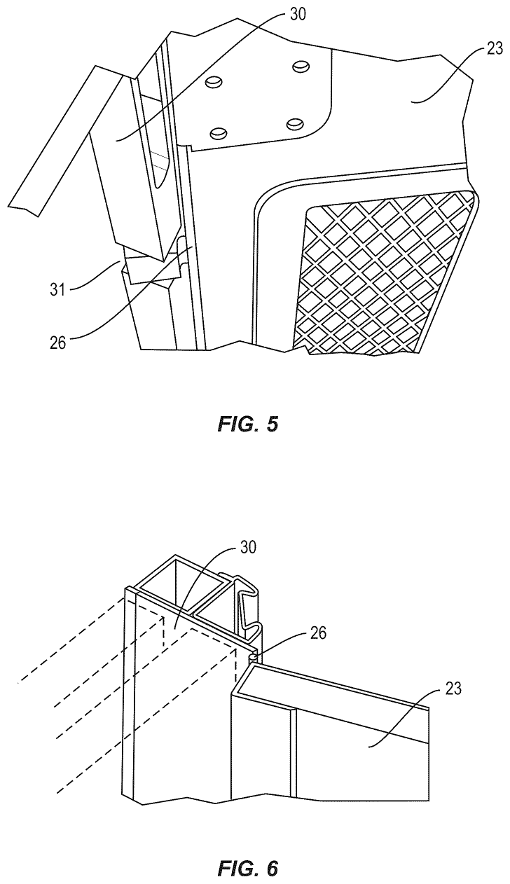

Panel 23 is mounted to the frame 30 by one or more frame hinges 26. In some examples, the frame hinges 26 are integrated into the frame 30. As illustrated in FIG. 5, the frame 30 includes a gap 31 that receives the hinge 26. The hinge 26 is positioned at the gap 31 and mounted to both of the frame 30 and panel 23. In some examples, the frame hinge 26 has a piano hinge geometry. As illustrated in FIG. 6, the hinge 26 connects the panel 23 to the frame 30. In some examples, the frame hinge 26 is positioned on the front side 21 of the barrier door 20. This allows the barrier door 20 to resist loads toward the flight deck 110 more effectively.

The barrier door 20 further includes a latch 40 to secure the panels 23, 24 in the extended configuration when deployed across the opening 113. In some examples as illustrated in FIGS. 3 and 4, the latch 40 is positioned at the inner edges 29 of the panels 23, 24. The latch 40 is mounted to one of the panels 23, 24 and includes an actuator 43 operatively connected to a movable member. The actuator 43 is movable to selectively position the movable member between an engaged position that engages with the opposing panel 23, 24, and a disengaged position. The actuator 43 can include various constructions including but not limited to a rotary handle or a sliding knob.

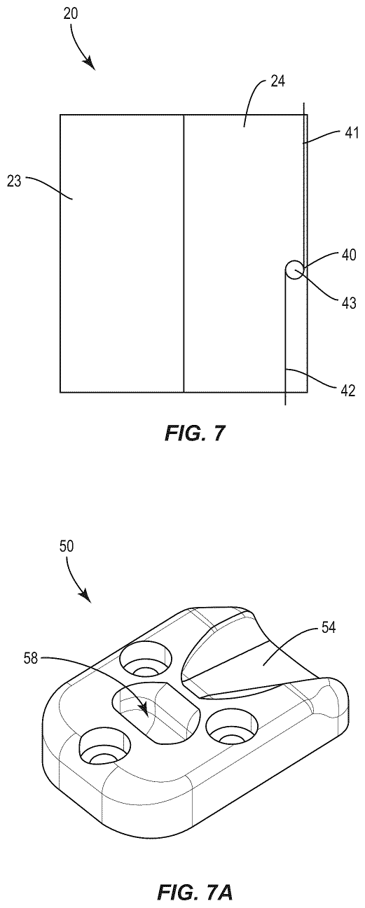

Additionally or alternatively, the latch 40 includes one or more members that engage with the ceiling and/or floor. As illustrated in FIG. 7, the latch 40 includes a pair of opposing members 41, 42 that are operatively connected to an actuator 43. The actuator 43 is movable to selectively position the members 41, 42 outward beyond the panel 24 to engage with the ceiling and/or floor. The actuator 43 can also position the members 41, 42 inward to disengage from the ceiling and/or floor. FIG. 7 illustrates an example with a pair of members 41, 42. In other examples, the latch 40 includes a single member 41 to secure with just one of the ceiling or floor.

In some examples as illustrated in FIG. 7A, anchors 50 are configured to be mounted to the floor 107 and/or ceiling 108. The anchor 50 includes a pocket sized to receive the end of a member 41/42. The anchor 50 also includes a slot 54 to receive the panel 24 when the barrier door 20 is in the extended configuration.

In some examples, the actuator 43 is positioned on the front side 21 of the barrier door 20. This provides for access by flight personnel to lock and unlock the latch 40.

The frame 30 is configured to receive the barrier door 20 in the stowed position. The frame 30 is positioned in proximity to the opening 113. In some examples, the frame 30 is positioned along an edge of the opening 113 (e.g., adjacent to a monument 112). This positioning causes a minimum of interference with people passing through the opening 113.

FIGS. 3 and 4 illustrate a frame 30 that includes a pair of posts 32, 33 and a header 34. A gap 35 is formed between the posts 32, 33 and header 34 and is sized to receive the barrier door 20 in the stowed position. In some examples, the gap 35 is substantially the same size as one of the panels 23, 24 because the panels 23, 24 are folded together when in the stowed position.

The frame 30 is positioned to stow and protect the barrier door 20 when not deployed. In some examples as illustrated in FIG. 3, the frame 30 is aligned in proximity to the monument 112. The header 34 is positioned along the monument and parallel to a center line of the opening 113.

In some examples, the frame 30 is mounted to the aircraft structure other than the monuments 112. In one example as illustrated in FIGS. 3 and 4, the bottom ends of the posts 32, 33 are mounted to the floor 107 and the header 34 is mounted to the ceiling 108.

In some examples, the posts 32, 33 and header 34 are separate extruded, machined parts that are rigidly bolted together. The bottom ends of the posts 32, 33 have separate floor mounted fittings which allow the frame 30 to pivot upright during installation. The header 34 has a spring loaded blade fittings to accommodate installation and accommodate relative deflection.

Anchors 50 are mounted to one or both of the floor 107 and ceiling 108 to secure the barrier door 20 in the deployed position. The anchors 50 are positioned on an opposing side of the opening 113 from the frame 30. In some examples, the anchors 50 have a low profile to prevent/reduce a person from tripping.

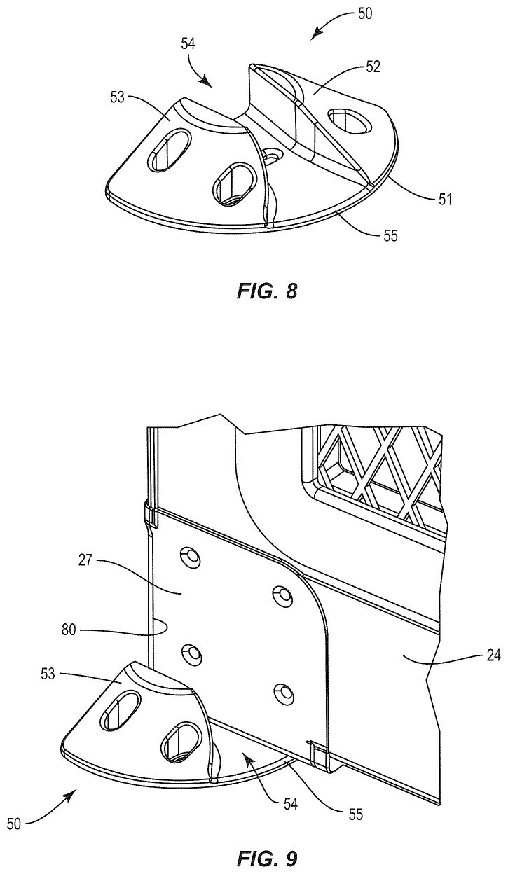

As illustrated in FIGS. 8 and 9, the anchors 50 include a flat outer side 51 that contacts against the floor 107/ceiling 108. The inner side includes a pair of extensions 52, 53 that are spaced apart by a slot 54. The slot 54 includes a tapered shape that is wider at one edge and tapers downward along the length. The anchor 50 is mounted with the wider portion of the slot facing into the opening 113. During use, the outer edge 80 of the panel 24 is inserted into wide portion of the slot 54. As the panels 23, 24 are unfolded, the panel 24 moves farther into the slot 54 and is secured between the two extensions 52, 53.

In some examples as illustrated in FIG. 9, the panel 24 includes one or more plates 27 at the outer edge 80. The plates 27 are mounted to one or both of the front side 21 and the rear side 22 along the section that is inserted into the slot 54.

In some examples, the barrier door system 10 is mounted to the structure of the aircraft 100 but not to the monuments 112. The frame 30 and anchors 50 are mounted to one or more of the floor 107 and ceiling 108 but not to the monuments 112. The barrier door 20 is mounted to the frame 30 through the frame hinge 26. In some examples, this mounting provides for a barrier door system 10 to be installed on existing aircraft 100 without changing the monuments 112.

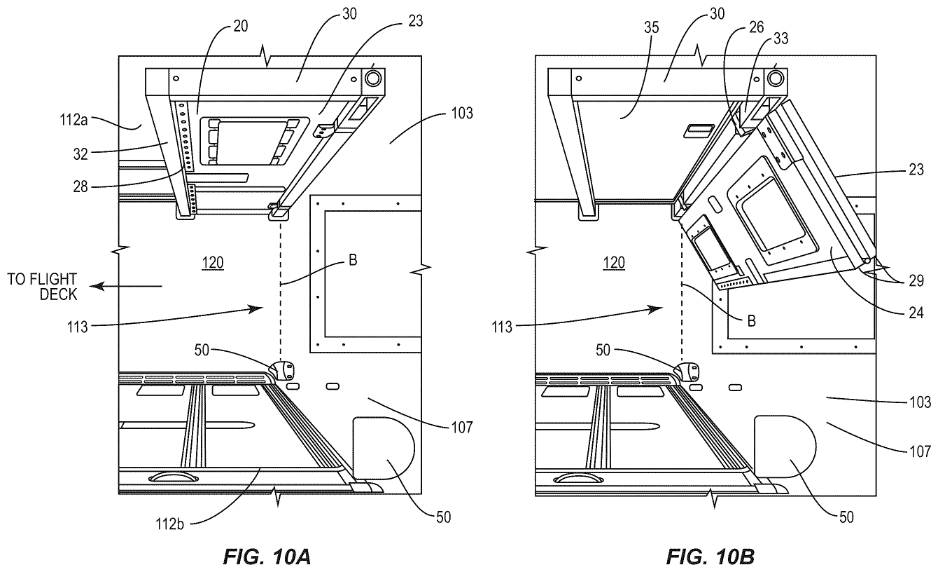

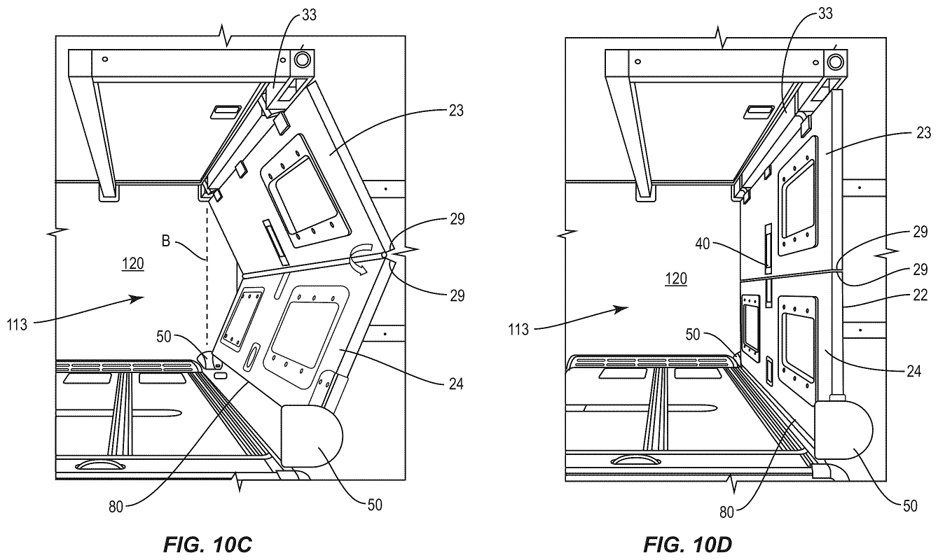

The barrier door 20 is movable between the stowed position while in a folded configuration and a deployed position while in an extended configuration. FIGS. 10A-10D illustrate an example of the barrier door 20 being deployed. In this example, the frame 30 is positioned along a first edge of the opening 113 adjacent to a first monument 112b. Anchors 50 are mounted to the floor 107 and ceiling on an opposing second edge of the opening 113 adjacent to a second monument 112d.

As illustrated in FIG. 10A, the barrier door 20 is in a folded configuration and stowed within the frame 30. The panels 23, 24 are folded together in an overlapping configuration with panel 23 being exposed and panel 24 being covered. In this folded configuration, just the rear side of panel 23 is exposed and visible. The front side 21 of the panel 23 is not exposed. In some examples, one or both of the panel hinge 25 and the frame hinge 26 are hidden in the stowed position.

In some examples, the panels 23, 24 are recessed inward from or flush with the front edge of the frame 30 when in the stowed position. This protects the panels 23, 24 from being damaged such as by being hit by luggage carried by passengers, galley carts being pushed through the opening 113, and persons as they walk through the opening 113. The latch 28 mounted on the rear side of the panel 23 is extended into an opening in the post 32 to secure the barrier door 20 in the stowed position.

FIG. 10B illustrates the barrier door 20 pivoted about the post 33 and out of the gap 35 in the frame 30. Prior to the movement, the latch 28 is disengaged to allow for the pivoting movement. The panels 23, 24 remain in a folded configuration and are positioned outward in the opening 113. The inner edges 29 of the panels 23, 24 are positioned outward away from the frame 30 and in the cabin area 103.

FIG. 10C illustrates the barrier door 20 with the panels 23, 24 folded outward an additional amount. The panels 23, 24 are positioned at a non-parallel angle. The outer edge 80 of panel 24 is aligned and guided into the slots in the anchors 50.

FIG. 10D illustrates the barrier door 20 in the deployed position with the panels 23, 24 in the extended configuration across the opening 113. The panels 23, 24 are aligned together in a colinear manner with the inner edges 29 abutting together. The outer edge 80 of the panel 24 is inserted fully into the slots in the anchors 50. The latch 40 is engaged to maintain the barrier door 20 in the deployed position.

The barrier door system 10 forms a boundary across the opening 113 when in the deployed position. As illustrated in FIGS. 10A-10C, a boundary line B shown by a dashed line is defined between the post 33 and the anchors 50. During deployment, the panels 23, 24 are pivoted such that the inner edges 29 are positioned on the cabin area side of the boundary line B. In one example as illustrated in the progression from FIG. 10A to FIG. 10B, the panels 23, 24 are pivoted about 135° between the stowed position (FIG. 10A) and the partially-deployed position (FIG. 10B). As illustrated in the progression from FIG. 10B to FIG. 10C, the deployment includes unfolding the panel 24 relative to panel 23. In some examples, the panel 24 is pivoted inward about 135. The inner edges 29 remain on the cabin side of the boundary line B.

The barrier door 20 is fully deployed by pivoting the panels 23, 24 together and bringing the inner edges 29 into alignment along the boundary line B. A force applied against the rear side 22 results in the inner edges 29 abutting together. This assists the barrier door 20 to resist loads towards the flight deck more effectively. The barrier door 20 can be aligned at different angles relative to the side walls of the opening 113 when in the deployed position. In some examples, the barrier door 20 is perpendicular to the side walls. In other examples, the barrier door 20 is at different angles relative to the side walls.

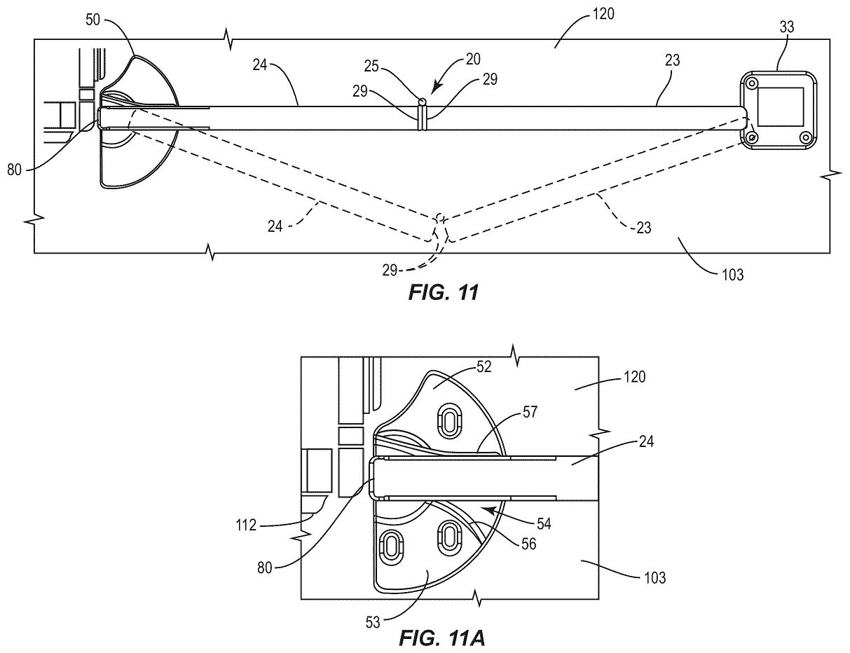

FIG. 11 illustrates the movement of the barrier door 20 from a partially deployed position (shown in dashed lines) to a stowed position (shown in solid lines) in the extended configuration. In the partially deployed position, the panels 23, 24 are positioned a non-parallel arrangement. A gap is positioned between the inner edges 29. In the deployed position, the panels 23, 24 are aligned in a straight line with longitudinal centerlines aligned together. The inner edges 29 are abutted together. The outer edge 80 of panel 24 is fully seated in the anchor 50. As illustrated in the enlarged view of FIG. 11A, the panel 24 is positioned in the slot 54 formed between the extensions 52, 53. In some examples, the extensions 52, 53 are shaped with the front edge of the slot 54 being wider to receive the outer edge 80. In one example, extension 53 that is positioned towards the cabin area 103 includes a curved front edge 56 to provide for the wider slot opening. Extension 52 positioned towards the flight deck 110 has a flat edge 57. The flat edge 57 supports the panel 24 transferring loads into the floor 107. In one example, the flat edge 57 is perpendicular to the floor of the slot 54.

In some examples as illustrated in FIG. 11A, the anchor 50 is mounted at the opening 113 with a centerline of the slot 54 aligned perpendicular to an edge of the monument 112. In some examples, the slot 54 is aligned with the centerline co-linear with the boundary line B. In some examples, the centerline of the slot 54 is angled to be non-perpendicular to the edge of the monument 112 and not aligned co-linear with the boundary line B. In some examples, this configuration provides for receiving the panel 24 when the barrier door 20 is aligned at different angular positions within the opening 113.

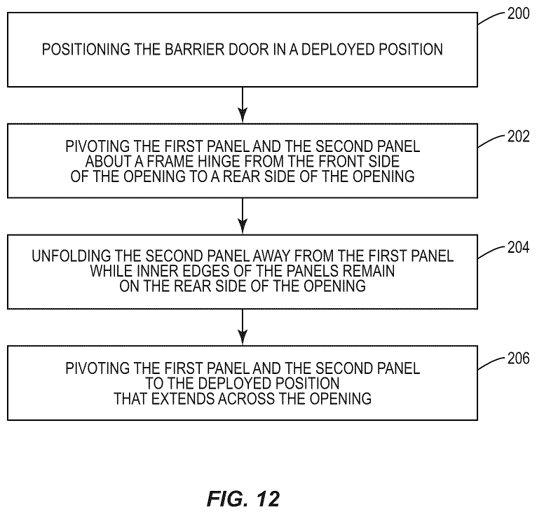

FIG. 12 illustrates a method of deploying a barrier door 20 within an interior of an aircraft 100. The barrier door 20 is positioned in a stowed position within a gap 35 in a frame 30 and with a first panel 23 and a second panel 24 in a folded configuration (block 200). The first panel 23 and the second panel 24 are positioned on a front side of an opening 113. The first panel 23 and the second panel 24 are pivoted about a frame hinge 26 from the front side of the opening 113 to a rear side of the opening 113 (block 202). The second panel 24 is unfolded away from the first panel 23 while inner edges 29 of the panels remain on the rear side of the opening 113 (block 204). The first panel 23 and the second panel 24 are pivoted to the deployed position that extends across the opening 113 and with the inner edges 29 of the panels positioned together (block 206).

In some examples, the frame 30 is recessed within a monument 112 or wall 114. The recessed position locates the frame 30 away from the opening 113.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A barrier door system to control movement of persons through an opening in an interior space of an aircraft, the barrier door system comprising:
a frame that comprises outer members that extend around a gap; and
a barrier door comprising a first panel and a second panel that are pivotally connected together with the barrier door pivotally connected to the frame, wherein the barrier door is movable between a stowed position and a deployed position;
wherein the stowed position comprising the first panel and the second panel folded together in an overlapping configuration and positioned in the gap in the frame and away from the opening; and
wherein the deployed position comprising the first panel and the second panel positioned away from the gap and extending across the opening.

2. The barrier door system of claim 1, wherein the frame comprises a first post and a second post with bottom ends configured to connect to a floor of the aircraft and a header that extends across top ends of the first post and the second post.

3. The barrier door system of claim 2, wherein the barrier door further comprises one or more additional panels, the one or more additional panels are connected to the first panel and the second panel and are folded together in the stowed position.

4. The barrier door system of claim 1, wherein each of the first panel and the second panel comprises a front side and a rear side with the front sides facing together in the stowed position.

5. The barrier door system of claim 4, wherein just the rear side of the first panel is exposed in the frame in the stowed position.

6. The barrier door system of claim 1, further comprising anchors configured to receive an outer edge of the second panel in the deployed position with the anchors comprising a slot with a width that tapers inward away from the opening.

7. The barrier door system of claim 6, wherein the anchors comprise a forward extension and a rear extension that are spaced apart by the slot with the forward extension comprising a vertical wall that is contacted by the second panel in the deployed position.

8. The barrier door system of claim 1, wherein the first panel is configured to pivot greater than 90° about the frame to enable the barrier door to move from the stowed position to the deployed position.

9. The barrier door system of claim 1, further comprising a frame hinge that connects the first panel to the frame with the frame hinge being covered and not visible from a cabin area of the aircraft in both the stowed position and the deployed position.

10. The barrier door system of claim 1, wherein the barrier door and the frame are mounted to one or more of a ceiling and a floor of the aircraft and are positioned away from one or more monuments within the aircraft.

11. The barrier door system of claim 1, further comprising a latch mounted to one or more of the first panel and the second panel with the latch configured to secure the first panel and the second panel together in the deployed position.

12. A barrier door system mounted at an opening in an interior space of an aircraft with the opening formed between a first side wall, a second side wall, a floor, and a ceiling, the barrier door system comprising:
a frame comprising outer members that form a gap;
a barrier door comprising a first panel and a second panel that are pivotally connected together with the first panel pivotally mounted to the frame;
one or more anchors mounted to one or both of the floor and the ceiling at the second side wall; and
wherein the barrier door is movable between a stowed position and a deployed position, the stowed position comprises the first panel and the second panel folded together in an overlapping configuration and positioned in the gap in the frame and the deployed position comprises the first panel and the second panel positioned in a non-overlapping configuration and positioned out of the gap and extending across the opening.

13. The barrier door system of claim 12, wherein the first panel and the second panel are positioned in an end-to-end configuration in the deployed position.

14. The barrier door system of claim 12, wherein the frame is mounted with the gap aligned parallel to the first side wall.

15. The barrier door system of claim 12, wherein the first side wall is formed by a first monument and the second side wall is formed by a second monument and wherein the frame, the barrier door, and the one or more anchors are mounted to just one or more of the floor and the ceiling.

16. The barrier door system of claim 12, further comprising a frame hinge that connects the first panel to the frame, wherein the frame hinge is positioned on a front side of the barrier door and away from a cabin area of the aircraft in the deployed position.

17. The barrier door system of claim 12, wherein the barrier door is aligned perpendicular to each of the first side wall and the second side wall in the deployed position.

18. The barrier door system of claim 12, wherein the barrier door is positioned rearward of a flight deck door within the interior space of the aircraft.

19. A method of deploying a barrier door within an interior of an aircraft, the method comprising:
positioning the barrier door in a stowed position within a gap in a frame and with a first panel and a second panel of the barrier door in a folded configuration with the first panel and the second panel positioned on a front side of an opening in the aircraft;
pivoting the first panel and the second panel about a frame hinge from the front side of the opening to a rear side of the opening and the frame hinge connects the barrier door to the frame; and
pivoting the first panel and the second panel to the deployed position that extends across the opening and with inner edges of the first panel and the second panel positioned together.

20. The method of claim 19, further comprising engaging a latch and securing the first panel and the second panel in the deployed position.
